(19) United States
(12) Patent Application Publication
(10) Pub. No.: US 2024/0303392 A1
(43) Pub. Date: Sep. 12, 2024

(54) FABRIC SIMULATION DEVICE AND METHOD

(71) Applicant: TG3D Studio, Taipei City (TW)

(72) Inventors: Sing-Heng YANG, Taipei City (TW); Meng-Shiuan HSIEH, Taipei City (TW)

(21) Appl. No.: 18/596,654

(22) Filed: Mar. 6, 2024

(30) Foreign Application Priority Data
Mar. 6, 2023 (TW) 112108094

(51) Int. Cl. G06F 30/20; G06N 3/08

(52) U.S. Cl. CPC G06F 30/20; G06N 3/08

(57) ABSTRACT

A fabric simulation device and method are provided. The device captures a physical deformation parameters corresponding to a fabric. A fabric specification information includes a fabric category data, a fabric combination data and a fabric weight data. The device generates target-encoding data by conducting a target-encoding algorithm on the fabric category data. The device generates a language processing vector by conducting a natural language processing algorithm on the fabric combination data. The device generates a category vector and a normalized physical deformation parameter by normalize the target-encoding data and the physical deformation parameter, and generate a weight vector by normalize the fabric weight data. The device generate a feature vector by concatenating the category vector, the language processing vector, and the weight vector. The device updates the neural network model according to the feature vector and the normalized physical deformation parameters.

### CROSS-REFERENCE TO RELATED APPLICATIONS

This application claims priority to Taiwan Application Serial Number 112108094, filed on Mar. 6, 2023, which is herein incorporated by reference in its entirety.

### BACKGROUND

### Technical Field

The present disclosure relates to a virtual simulation method. More particularly, the present disclosure relates to a fabric simulation device and method.

### Description of Related Art

In present textile technologies, the technique of simulating a virtual fabric (or cloth) in a three-dimensional space is often adopted, so as to observe drapes and motions of the virtual fabric in the three-dimensional space. This may usually require measuring physical deformation parameters (e.g., bending works in the warp/weft direction, stretch rates in the warp/weft/oblique direction) of the fabric, so as to perform further simulations. However, it may take a long time and a large amount of manpower to measure physical deformation parameters of the fabric, where specific testing machines may also be required. Therefore, to get physical deformation parameters of the fabric without measuring them is a problem that people with ordinary skills in the art.

### SUMMARY

The present disclosure provides a fabric simulation device, comprising a data capturing circuit, a memory and a processor. The data capturing circuit is configured to capture a physical deformation parameters corresponding to a fabric. The memory is configured to store a fabric specification information corresponding to the fabric. The fabric specification information comprises a fabric category data, a fabric combination data and a fabric weight data. The processor is coupled to the data capturing circuit and the memory and configured to apply a neural network model. The processor is configured to: generate target-encoding data by conducting a target-encoding algorithm on the fabric category data; generate a language processing vector by conducting a natural language processing algorithm on the fabric combination data; generate a category vector and a normalized physical deformation parameter by conducting a first normalization operation on the target-encoding data and the physical deformation parameter, and generate a weight vector by conducting a second normalization operation on the fabric weight data; generate a feature vector by concatenating the category vector, the language processing vector and the weight vector; and update the neural network model according to the feature vector and the normalized physical deformation parameters.

The present disclosure provides a fabric simulation method for an electronic device, comprising: generate target-encoding data by conducting a target-encoding algorithm on a fabric category data, wherein the fabric specification information corresponds to a fabric, and the fabric specification information comprises the fabric category data, a fabric combination data and a fabric weight data; generate a language processing vector by conducting a natural language processing algorithm on the fabric combination data; generate a category vector and a normalized physical deformation parameter by conducting a first normalization operation on the target-encoding data and the physical deformation parameter, and generate a weight vector by conducting a second normalization operation on the fabric weight data, wherein the physical deformation parameters corresponds to the fabric; generate a feature vector by concatenating the category vector, the language processing vector and the weight vector; and update a neural network model according to the feature vector and the normalized physical deformation parameters.

It is to be understood that both the foregoing general description and the following detailed description are by examples, and are intended to provide further explanation of the disclosure as claimed.

### BRIEF DESCRIPTION OF THE DRAWINGS

FIG. 1A is a schematic diagram of simulating a piece of real fabric in present textile technologies.

FIG. 1B is a simplified functional block diagram of a fabric simulation device according to one embodiment of the present disclosure.

FIG. 1C is an schematic diagram of training stages according to some embodiments of the present disclosure.

FIG. 2 is a flowchart of a fabric simulation method according to one embodiment of the present disclosure.

FIG. 3 is a flowchart of detailed steps of one of steps in FIG. 2 according to some embodiments of the present disclosure.

FIG. 4 is a flowchart of detailed steps of another one of steps in FIG. 2 according to some embodiments of the present disclosure.

FIG. 5 is a flowchart of detailed steps of another one of steps in FIG. 2 according to some embodiments of the present disclosure.

FIG. 6 is a schematic diagram of a data filtering process through a box plot.

FIG. 7 is a schematic diagram of stages of use of the fabric simulation device according to some embodiments of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

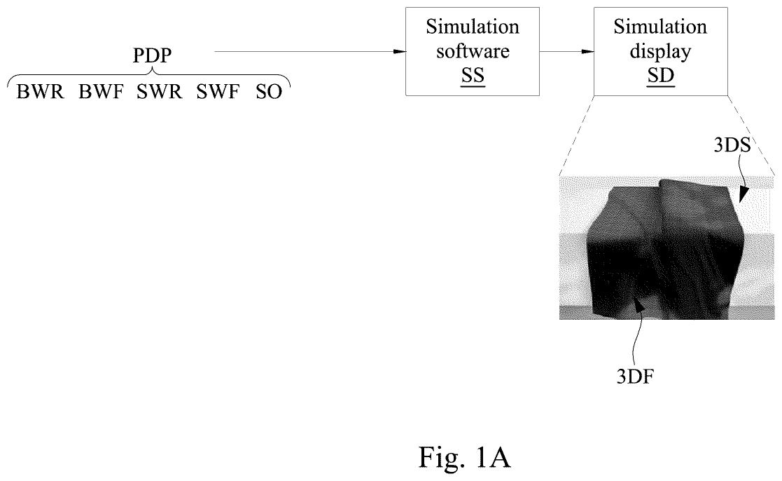

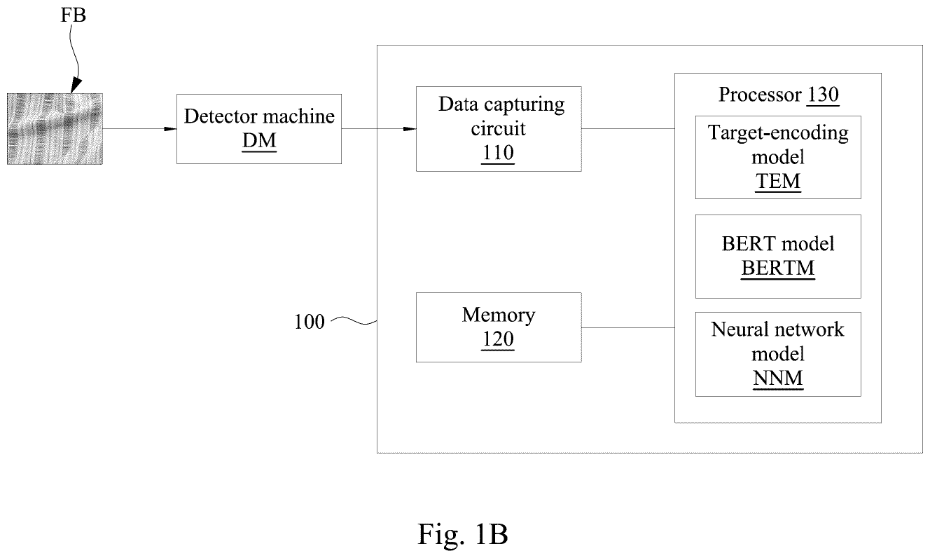

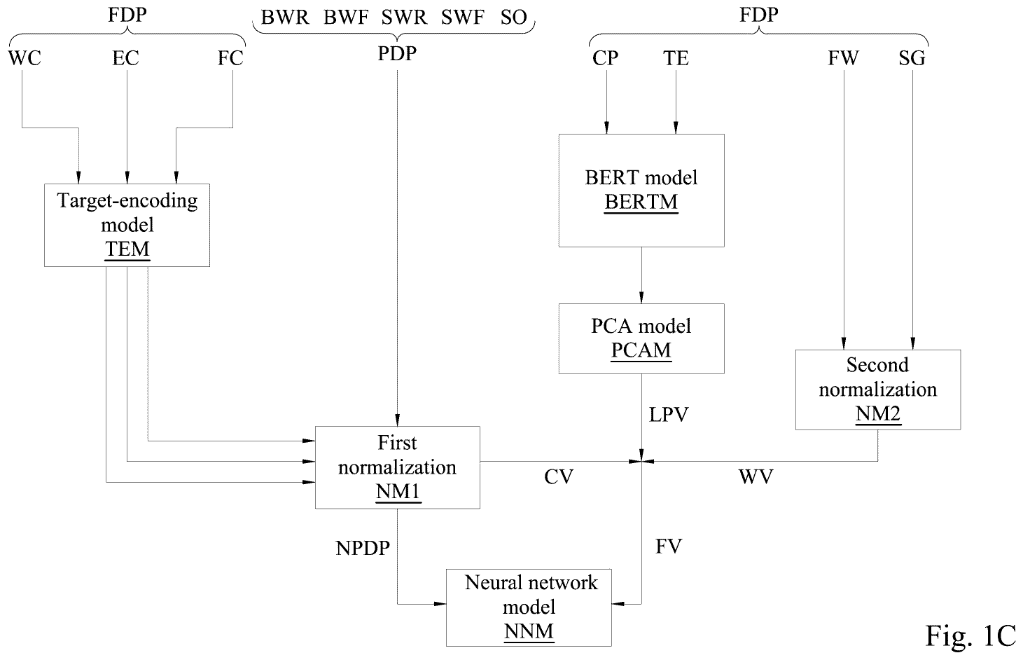

Refer to FIG. 1A, where FIG. 1A is a schematic diagram of simulating a piece of real fabric in present textile technologies. In order to provide a realistic fabric simulation, physical deformation parameters PDP corresponding to the fabric are often required. Through a simulation software SS (e.g., three-dimensional simulation software such as Scanatic™ DC Suite), a virtual three-dimensional space 3DS may be generated and simulate various drapes and motions of a virtual fabric 3DF in the virtual three-dimensional space 3DS according to physical deformation parameters PDP. Consequently, a simulation display SD (e.g., a monitor, a touch display or a head-mounted display) may display various drapes and motions of a virtual fabric 3DF in the virtual three-dimensional space 3DS.

In general, a complicated process may be required to measure physical deformation parameters PDP of the fabric, where the physical deformation parameters PDP may include a bending work in the warp direction BWR, a bending work in the weft direction BWF, a stretch rate in the warp direction SWR, a stretch rate in the weft direction SWF and a stretch rate in the oblique direction SO.

More specifically, the bending work in the warp direction BWR is a work required for bending the fabric against/along the warp direction, and a unit of the bending work in the warp direction BWR is a product of a gram-force, a bending length and a bending angle (gf×mm×rad). The bending work in the weft direction BWF is a work required for bending the fabric against/along the weft direction, and the unit of bending work in the weft direction BWF is also the product of the gram-force, the bending length and the bending angle.

Additionally, the stretch rate in the warp direction SWR is defined according to a strip method of a breaking strength in the CNS 12915 L3233-2010 standard, which is a measurement of a stretch rate while stretching the fiber in a constant speed CRE with a fixed weight of 500 gw of load along the warp direction of the fiber, and the unit of the stretch rate in the warp direction SWR is percentage (%). The stretch rate in the weft direction SWF is defined according to the strip method of the breaking strength in the CNS 12915 L3233-2010 standard as a stretch rate while stretching the fiber in a constant speed CRE with a fixed weight of 500 gw of load along the weft direction of the fiber, and the unit of the stretch rate in the weft direction SWF is percentage (%). The stretch rate in the oblique direction SO is defined according to the strip method of the breaking strength in the CNS 12915 L3233-2010 standard as a stretch rate while stretching the fiber in a constant speed CRE with a fixed weight of 500 gw of load along the oblique direction (the direction with an angle of 34 degrees to the weft direction) of the fiber, and the unit of the stretch rate in the oblique direction SO is percentage (%). In other words, each of the bending work in the warp direction BWR, the bending work in the weft direction BWF, the stretch rate in the warp direction SWR, the stretch rate in the weft direction SWF and the stretch rate in the oblique direction SO is a numerical data, respectively.

The aforementioned stretch rate in the warp direction SWR, stretch rate in the weft direction SWF and stretch rate in the oblique direction SO may all be computed as Formula 1.

$$( \frac{Ds - Dc}{Dc} ) \times 100 \% \qquad ( Formula 1 )$$

In formula 1, the clamping distance Dc is a distance between two clamping positions on the fabric, and the stretching displacement Ds is a stretching length of the fabric under a fixed weight of 500 g of load.

However, it can be known from above that since physical deformation parameters PDP such as the bending work in the warp direction BWR, the bending work in the weft direction BWF, the stretch rate in the warp direction SWR, the stretch rate in the weft direction SWF and the stretch rate in the oblique direction SO may only be measured by applying a constant force on the fabric and then measuring a variety of quantities of deformation of the fabric. As a result, the whole measuring process becomes complicated and lengthy.

Since currently the measuring process of physical deformation parameters PDP on an ordinary fabric simulation device is complicated and lengthy, while the efficiency of the simulation is poor as well. To overcome the aforementioned problems, the present disclosure provides a fabric simulation technology, where physical deformation parameters PDP corresponding to each fabric measured in advance are pre-processed along with specification of each fabric, so as to train a neural network (NN) model.

Therefore, if a new fabric is up to be simulated, fabric specification information corresponding to a new fabric may be acquired in advance (which may be acquired easily in a fabrication stage, or may be provided directly by manufacturers performing the fabrication), and then utilize a well-trained NN model to transform new fabric specification information into new physical deformation parameters. Therefore, through the aforementioned simulation method, various drapes and motions of a new virtual fabric in the three-dimensional space 3DS may be simulated according to new physical deformation parameters. A new fabric may be simulated solely with easily-acquired new fabric specification information, and then new physical deformation parameters may be recognized rapidly without the complicated and time-consuming measurement of new physical deformation parameters. The aforementioned technology of the present disclosure may be specified by following embodiments.

Also refer to FIG. 1B, wherein FIG. 1B is a simplified functional block diagram of a fabric simulation device 100 according to one embodiment of the present disclosure. As shown in FIG. 1B, in the present embodiment, the fabric simulation device 100 comprises a data capturing circuit 110, a memory 120 and a processor 130. The processor 130 is coupled to the data capturing circuit 110 and the memory 120.

In some embodiments, the fabric simulation device 100 may be implemented with a computer, a server or a processing center. In the present embodiment, the data capturing circuit 110 may be a processing circuit configured to capture physical deformation parameters corresponding to a fabric FB (e.g., a piece of cloth). In some embodiments, when a detector machine DM is utilized to perform extending and bending tests on the fabric FB in order to generate physical deformation parameters PDP, the data capturing circuit 110 may capture physical deformation parameters PDP corresponding to the fabric FB directly from detector machine DM, where the detector machine DM may be a machine configured to detect a deformation (bending and extending) on the fabric to be detected. In other embodiments, when the detector machine DM is utilized to perform extending and bending tests on the fabric FB in order to generate physical deformation parameters PDP, the detector machine DM may store the detector machine PDP in an external database (not depicted), so the data capturing circuit 110 capture physical deformation parameters PDP corresponding to the fabric from the external database.

In the present embodiment, the memory 120 is configured to store a fabric specification information corresponding to the fabric FB. The fabric specification information includes a fabric classification data, a fabric combination data and a fabric weight data. It should be noted that the fabric FB is the same as the fabric FB configured to detect physical deformation parameters in the previous paragraph. In other words, for a single fabric FB, physical deformation parameters PDP and the fabric specification information corresponding to the fabric FB may be acquired.

In some embodiments, the memory 120 may be implemented with a memory unit, a flash memory, an ROM, an HDD or any equivalent storage component.

In some embodiments, the fabric specification information includes a weaving category, an elastic category and a fabric category. For example, the weaving category may be one of various weaving categories such as warp knit, weft knit, plain weave or twill weave. The weaving category may be one of various elastic specifications such as non-elastic, 4-way elastic, warp elastic, weft elastic. The fabric category may be a fabric specification such as dobby, single jersey fleece/plush, tricot fleece/tricot brush or lamination. In other words, each of the weaving category, the elastic category and the fabric category is a string.

In some embodiments, the fabric combination data may include a composition combination and a textile-finishing combination. For example, the composition combination may be a fiber composition specification such as 60% nylon fiber and 40% polyester fiber, 92% polyester fiber and 8% spandex fiber, 50% cationic (cd) polyester fiber and 50% polyester fiber or 77% nylon fiber and 23% polyurethane (pu). The textile-finishing may be unfinished, brush with embossing or brush. In other words, each of the composition combination and the textile-finishing combination is a string including a plurality of strings, respectively.

In some embodiments, the fabric weight data may include a fabric weight and a specific gravity, where the unit of the fabric weight is GSM, and the fabric weight is a ratio between two densities. In other words, each of the fabric weight and the specific gravity is a numerical data, respectively.

To sum up, the fabric specification information of the fabric FB includes specification data such as categories, types, compositions and weights. In one embodiment, the fabric specification information of the fabric FB may be provided by a manufacturer of the fabric FB, or determined based on a simple analysis on the fabric FB (e.g., to determine weavings, compositions or to measure weights, etc.). The aforementioned fabric specification information of the fabric FB may be acquired without performing extension or bending tests on the fabric FB.

It should be noted that while the in present embodiment the fabric specification information corresponding to a fabric FB is taken as an example, in practical implementations, the memory 120 may be further configured to store fabric specification information corresponding to each of a plurality of fabrics, respectively.

As shown in FIG. 1B, the processor 130 executes a neural network model NNM based on corresponding software or firmware instructions. In some embodiments, the neural network model NNM is configured to perform a neural network algorithm. In some embodiments, the processor 130 may be implemented with a processing unit, a CPU or a computing/arithmetic unit. In some embodiments, the memory 120 may be configured to store parameters of the neural network model NNM, where the parameters may be averaged values determined according to previous trains, predetermined values or random values.

In one embodiment, the processor 130 is configured to perform a data preprocessing aforementioned measured physical deformation parameters PDP corresponding to the fabric FB and the fabric specification information corresponding to the fabric FB, and then train the neural network model NNM according to the processed data.

Refer also to FIG. 1C, where FIG. 1C is a schematic diagram of the data preprocessing of the physical deformation parameters PDP and fabric specification information FDP and training of the neural network model NNM according to some embodiments of the present disclosure. As shown in FIG. 1C, in one embodiment, the fabric specification information FDP may comprise the weaving category WC, the elastic category EC, the fabric category FC, the composition combination CP, the textile-finishing combination TF, the fabric weight FW and the specific gravity SG, and physical deformation parameters PDP may contain information such as bending works in the warp direction BWR, bending works in the weft direction BWF, stretch rates in the warp SWR, stretch rates in the weft direction SWF or stretch rates in the oblique direction SO. Moreover, one neural network model NNM may be trained according to one type of physical deformation parameters PDP.

In other words, a neural network model NNM for the bending work in the warp direction BWR may be trained for bending work the bending work in the warp direction BWR; a neural network model NNM for the bending work in the weft direction BWF may be trained for the bending work in the weft direction BWF; a neural network model NNM for the stretch rate in the warp direction SWR may be trained for the stretch rate in the warp direction SWR; a neural network model NNM for the stretch rate in the weft direction SWF may be trained for the stretch rate in the weft direction SWF; and a neural network model NNM for the stretch rate in the oblique direction SO may be trained for the stretch rate in the oblique direction SO.

It should be noted that although a single neural network model NNM (i.e., for a single type of physical deformation parameters PDP) is taken as an example, in practical implementations, different types of physical deformation parameters PDP may be utilized to train different neural network models NNM.

In some embodiments, the processor 130 may further implement a target-encoding model TEM and a bidirectional encoder representations from transformers (BERT) model BERTM based on corresponding software or firmware instructions. In addition, the processor 130 may further conduct a principal components analysis (PCA) operation and a normalization operation on data based on corresponding software or firmware instructions.

It should be noted that the target-encoding model TEM, the BERT model BERTM, the PCA operation and the normalization operation may be regarded as part of data preprocessing.

As shown in FIG. 1C, a category vector CV may be generated from the weaving category WC, the elastic category EC and the fabric category FC through the target-encoding model TEM and a first normalization operation NM1.

In some embodiments, the target-encoding model TEM is configured to execute a target-encoding algorithm. In some embodiments, the BERT model BERTM may use a plurality of English sentences (e.g., ten thousand sentences chosen from English books) to conduct a pre-training process, so as to generate a pre-trained encoder, and then use the encoder to encode the strings (e.g., English strings). In other embodiments, the BERT model BERTM may use a plurality of Chinese sentences (e.g., ten thousand sentences chosen from Chinese books) to conduct a pre-training process, so as to generate a pre-trained encoder, and then use the encoder to encode the strings (e.g., Chinese strings).

In some embodiments, the first normalization operation NM1 is configured to conduct a min-max normalization operation. The min-max normalization is represented as the following Formula 2.

$$y 1 = ( x 1 - min ) / ( max - min ) \qquad ( Formula 2 )$$

In Formula 2, x1 is a variable to be normalized, min is the minimum value of the variable to be normalized, max is the maximum value of the variable to be normalized, and y1 is a normalized variable according to the min-max normalization.

For example, for the bending work in the warp direction BWR corresponding to the fabric FB, a difference between the bending work in the warp direction BWR and the possible maximum value of the bending work in the warp direction BWR may be calculated, and a difference between the possible maximum value of the bending work in the warp direction BWR and possible minimum value of the bending work in the warp direction BWR may be calculated, and a ratio between the two difference may be calculated so as to generate a min-max normalized bending work in the warp direction corresponding to the fabric FB. The min-max normalized bending work in the warp direction corresponding is used as normalized physical deformation parameters NPDP.

In some embodiments, the bending work in the warp direction BWR, the bending work in the weft direction BWF, the stretch rate in the warp direction SWR, the stretch rate in the weft direction SWF or the stretch rate in the oblique direction SO may be pre-processed through the first normalization operation NM1, so as to generate normalized physical deformation parameters NPDP.

As shown in FIG. 1C, a language processing vector LPV may be generated from the composition combination CP and the textile-finishing combination TF through the BERT model BERTM and the PCA operation. A weight vector WV may be generated from the fiber weight FW and the specific gravity SG through the second normalization operation NM2.

In some embodiments, the PCA operation is configured to execute the PCA algorithm to remove outliers.

In some embodiments, the second normalization operation NM2 is configured to perform a Z-score normalization. The Z-score normalization operation is represented as the following Formula 3.

$$y 2 = ( x 2 - mean ) / stdv \qquad ( Formula 3 )$$

In formula 3, x2 is a variable to be normalized, mean is an average of the variable to be normalized, stdv is a standard deviation of the variable to be normalized, and y2 is a Z-score-normalized variable.

For example, for a weight corresponding to the fabric FB, a difference between the weight and an averaged value over a plurality of weights corresponding to a plurality of fabrics may be calculated, a standard deviation over a plurality of weights corresponding to a plurality of fabrics may also be calculated, and thereby acquire a Z-score-normalized weight corresponding to the fabric FB by dividing the difference by the standard deviation.

As shown in FIG. 1C, a feature vector FV may be acquired by concatenating the category vector CV, the language processing vector LPV and the weight vector WV. By this, normalized physical deformation parameters NPDP and the feature vector FV may be utilized to update parameters of the neural network model NNM. Detailed operations of the aforementioned models will be described in the following paragraphs.

In some embodiments, the fabric simulation device 100 is not limited to comprise the data capturing circuit 110, the memory 120 and the processor 130. The fabric simulation device 100 may further comprise other components required by operations and applications. For example, the fabric simulation device 100 may further comprise an output interface (e.g., a display panel configured to display information, or a VR/AR device), an input interface (e.g., a touch panel, a keyboard, a microphone, a scanner, a flash memory reader, or a VR/AR device) and a communication circuit (e.g., a Wi-Fi communication module, a Bluetooth communication module, or a wireless network module, etc.).

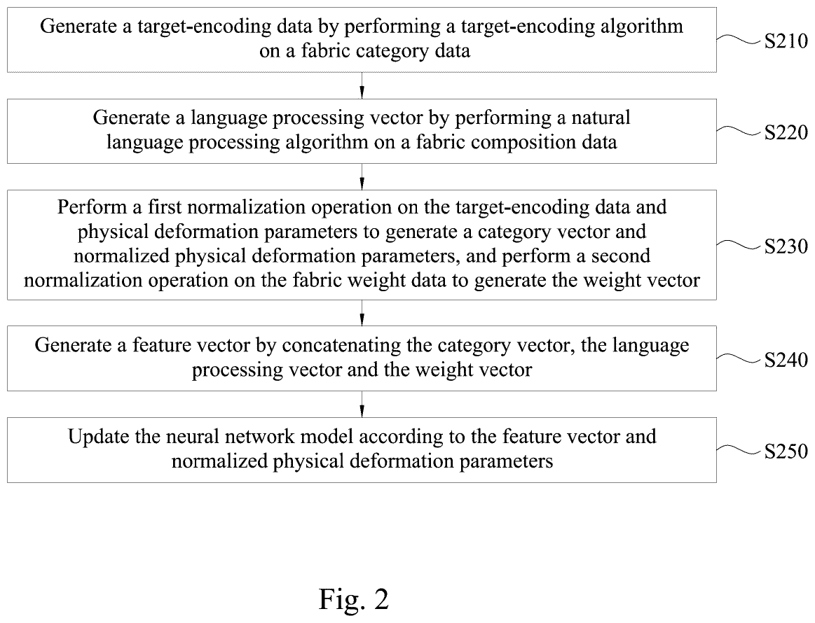

Refer also to FIG. 2, where FIG. 2 is a flowchart of a fabric simulation method according to one embodiment of the present disclosure. The method shown in FIG. 2 is suitable for, but not limited to, the fabric simulation device 100 of FIG. 1B. For convenience and clarity, detailed steps of the fabric simulation method shown in FIG. 2 are described through action relationship between components in the fabric simulation device 100 and processing of various data shown in FIG. 1B.

In the present embodiment, the fabric simulation method comprises steps S210-S250, and is executed by the processor 130. At first, in step S210, a target-encoding data is generated by performing a target-encoding algorithm on the fabric category data. In some embodiments, the fabric category data in the fabric specification information FDP (i.e., weaving category WC, elastic category EC and fabric category FC) corresponding to one fabric FB may be transformed into the target-encoding data through the target-encoding model TEM, so as to input the target-encoding data to the first normalization operation NM1. Detailed steps of step S210 in some embodiments will be further described in detail with specific examples.

In some embodiments, before performing the target-encoding algorithm, when simulations of a plurality of fabrics is required, a numerical filtering may be performed on physical deformation parameters (i.e., the bending work in the warp direction BWR, the bending work in the weft direction BWF, the stretch rate in the warp direction SWR, the stretch rate in the weft direction SWF or the stretch rate in the oblique direction SO) corresponding to each fabric and numerical data in fabric specification information (i.e., the fabric weight FW and the specific gravity SG).

More specifically, the fabric weight FW, the specific gravity SG, stretch rate in the warp direction BWR, the bending work in the weft direction BWF, the stretch rate in the warp direction SWR, the stretch rate in the weft direction SWF and the stretch rate in the oblique direction SO are all numerical data. Therefore, box plot corresponding to each of the fabric weight FW, the specific gravity SG, stretch rate in the warp direction BWR, the bending work in the weft direction BWF, the stretch rate in the warp direction SWR, the stretch rate in the weft direction SWF and the stretch rate in the oblique direction SO may be illustrated, and then discard the points lying outside the range of 1.5 times of the interquartile range (IQR) (i.e., select a fabric corresponding to the point, and discard physical deformation parameters and the fabric specification information corresponding to the fabric) in the seven box plots. In other words, if physical deformation parameters and the fabric specification information corresponding to one fabric contain outliers, the fabric may not be used in the process of simulation.

Therefore, based on the box plots, values in physical deformation parameters and fabric specification information that are outliers (i.e., physical deformation parameters and the fabric specification information corresponding to abnormal fabrics) may be deleted.

In step S220, a natural language processing (NLP) algorithm may be performed on the fabric combination data to generate the language processing vector LPV. In some embodiments, BERT model BERTM and PCA may be utilized to perform the NLP algorithm on the fabric combination data in the fabric specification information (i.e., the composition combination CP and the textile-finishing combination TF). In the following paragraphs, detailed steps of step S220 in some embodiments will be further described in detail with specific examples.

In step S230, the first normalization operation NM1 is performed on the target-encoding data and physical deformation parameters PDP to generate the category vector and normalized physical deformation parameters, and the weight vector may be generated by performing the second normalization operation NM2 on the fabric weight data.

In some embodiments, the first normalization operation NM1 may be the min-max normalization operation. In some embodiments, the second normalization NM2 may be the Z-score normalization operation. In some embodiments, the min-max normalization operation is performed on the target-encoding data and physical deformation parameters PDP, so as to generate the category vector and normalized physical deformation parameters. In some embodiments, the weight vector may be generated by performing the Z-score normalization on the fabric weight data (i.e., the fabric weight FW and the specific gravity SG).

Detailed steps of step S230 in some embodiments will be further described in detail with specific examples.

In step S240, the category vector, the language processing vector and the weight vector are concatenated to produce the feature vector. In some embodiments, the category vector, the language processing vector and the weight vector are concatenated one after another to generate the feature vector.

In step S250, the neural network model NNM is updated according to the feature vector and normalized physical deformation parameters.

In some embodiments, the feature vector may be used as training data, and use the corresponding normalized physical deformation parameters as a physical deformation vector, and thereby use the physical deformation vector as training labels corresponding to the training data. Then, the training data may be inputted into the neural network model NNM to generate predicted labels and calculate the loss (e.g., cross-entropy) between predicted labels and training labels, and thereby use the loss to perform a back-propagation algorithm, so as to update parameters of the neural network model NNM.

In other words, using a large number of physical deformation parameters with a specific type corresponding to a large amount of fabrics, with a large amount of fabric specification information, a neural network model NNM for a specific type of physical deformation parameters may be trained. By this, in the deployment stage, to generate new physical deformation parameters corresponding to a new fabric, the neural network model NNM only requires new fabric specification information corresponding to the specific type of the new fabric.

For example, in the training stage, the neural network model NNM for the bending work in the warp direction BWR may be trained by using a large number of bending works in the warp direction BWR and a large amount of fabric specification information corresponding to a large number of fabrics. By this, in the deployment stage, for the bending work in the warp direction BWR, a new bending work in the warp direction BWR correspond ding to a new fabric may be generated from the fabric specification information corresponding to the new fabric by the neural network model NNM for the bending work in the warp direction BWR. A similar method may be adopted to train neural network models NNM for other types of physical deformation parameters, and neural network models NNM for other types of physical deformation parameters may be used in the deployment stage.

Through aforementioned steps, the fabric simulation device 100 may predict physical deformation parameters from fabric specification information FDP corresponding to the fabric FB through a combination of a algorithms such as the target-encoding algorithm, the natural language processing algorithm, the first normalization operation NM1, the second normalization operation NM2 and a concatenation of vectors, which may reduce time and manpower consumed by additional measurement of physical deformation parameters, and thereby improve the efficiency of fabric simulation in the three-dimensional virtual space.

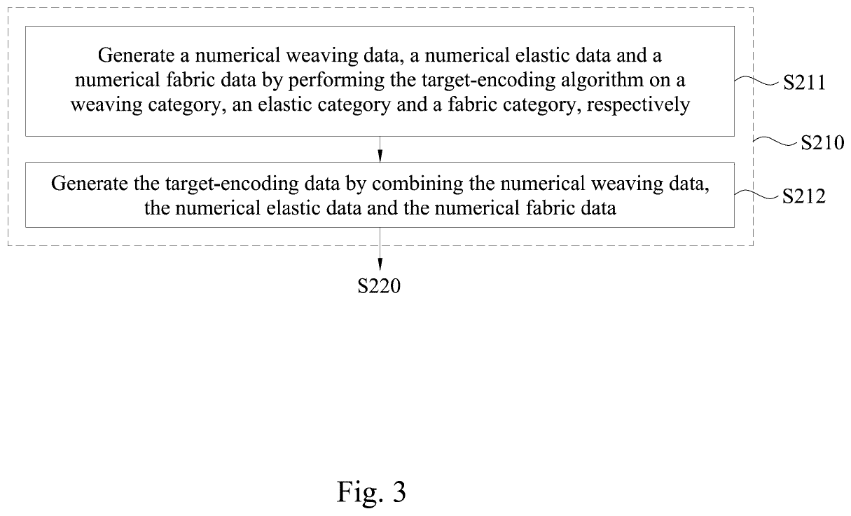

Refer also to FIG. 3, where FIG. 3 is a flowchart of detailed steps S211-S212 of step S210 in FIG. 2 according to some embodiments of the present disclosure. As shown in FIG. 3, in step S211, the target-encoding algorithm is performed on the weaving category WC, the elastic category EC and the fabric category FC respectively, so as to generate a numerical weaving data, a numerical elastic data and a numerical fabric data.

More specifically, since the weaving category WC, the elastic category EC and the fabric category FC in the fabric category data are all strings within finite types (e.g., five types of strings). For example, the weaving category WC may be a Chinese string of “warp knit” or an English string of “warp knit”. Therefore, for a neural network model NNM for physical deformation parameters of a specific type, the target-encoding algorithm may be utilized directly to transform these categories into a plurality of numerical values.

For example, if there are five possible weaving categories for a plurality fabrics, and a neural network model NNM for the bending work in the warp direction BWR is required, fabrics that belong to a first weaving category may be selected from the plurality of fabrics, and then an averaged value over the bending work in the warp direction BWR of these fabrics is calculated, and thereby transforming the string data of the first weaving category into the averaged value. The same method may be adopted to transform other weaving categories into numerical values. In addition, similar method may be adopted on elastic category EC and fabric category FC to perform a transformation.

It is worth mentioning that when a neural network model NNM for another type of physical deformation parameters is required, the only difference is that what is taken out is an averaged value of another type of physical deformation parameters. For example, if there are five possible weaving categories for a plurality fabrics, and a neural network model NNM for the bending work in the weft direction BWF is required, fabrics that belong to a first weaving category may be selected from the plurality of fabrics, and then an averaged value over the bending work in the weft direction BWF of these fabrics is calculated, and thereby transforming the string data of the first weaving category into the averaged value. The same method may be adopted to transform other weaving categories into numerical values. In addition, similar method may be adopted on elastic category EC and fabric category FC to perform a transformation.

In step S212, the target-encoding data is generated by a combination of the numerical weaving data, the numerical elastic data and the numerical fabric data. In other words, the target-encoding data comprises three parts of data, which are the numerical weaving data, the numerical elastic data and the numerical fabric data, respectively.

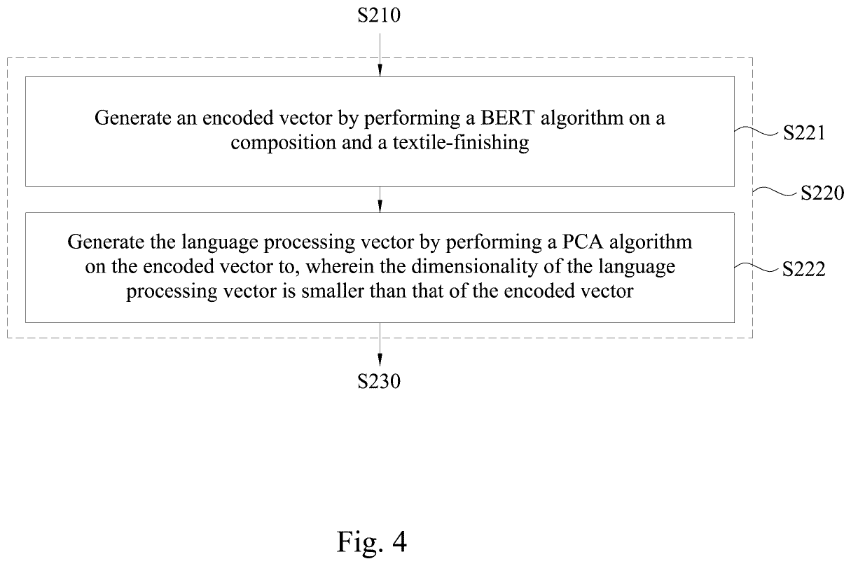

Refer also to FIG. 4, is a flowchart of detailed steps S221-S222 of step S220 in FIG. 2 according to some embodiments of the present disclosure. As shown in FIG. 4, in step S221, the BERT algorithm is performed on the composition combination CP and the textile-finishing combination TF, so as to generate an encoded vector.

In step S222, the PCA algorithm is performed on the encoded vector to generate the language processing vector LPV, where the dimensionality of the language processing vector LPV is smaller than that of the encoded vector.

More specifically, the composition combination CP and the textile-finishing combination TF in the fabric combination data are both strings including a plurality of strings, which may produce a large number of possible combinations of strings (e.g., one-hundred possible strings). Therefore, a pre-trained encoder in the BERT model BERTM is adopted to numericalize the fabric combination data, so as to generate an encoded vector with a higher dimensionality (e.g., a vector with a dimensionality of 1×384). Then, in order to filter abnormal values in the encoded vector, the PCA algorithm may be performed on the encoded vector to conduct a dimensionality-reduction on the encoded vector and generate a low-dimensional vector (e.g., a vector with a dimensionality of 1×31), and then use the low-dimensional vector as the language processing vector LPV.

Moreover, the BERT model BERTM may comprise an embedding module, an encoder and a fully-connected feedforward neural network. A large number of sentences in a corpus may be used to pre-train the encoder in the BERT model. By this, the encoder may be utilized to transform a plurality of fabric combination data corresponding to a plurality of fabrics into high-dimensional vectors.

For example, if the composition combination is a string “60% nylon and 40% polyester”, and the textile-finishing combination is a string “na (non-elastic)”, the encoder may be utilized to transform each of the two strings into a vector, and then concatenate the two vectors to produce a high-dimensional encoded vector.

Then, the PCA algorithm may be utilized to perform a dimensionality-reduction on the high-dimensional encoded vector to generate a low-dimensional language processing vector. Take the PCA that uses a plurality of high-dimensional encoded vectors to generate a two-dimensional coordinate as an example, a covariance matrix may be generated according to values of a plurality elements in each of high-dimensional encoded vectors, and then decompose the covariance matrix into a plurality of eigenvalues and a plurality of feature vectors (i.e., eigenvectors). Then, two largest eigenvalues may be selected and then use the two feature vectors corresponding to the two eigenvalues to generate a projection matrix, where the first two rows of the projection matrix are picked out to use as a weight matrix. By this, a plurality of candidate coordinates corresponding to each element according to high-dimensional encoded vectors and the weight matrix, where each of the plurality of candidate coordinates is a corresponding coordinate to each element in a two-dimensional plane.

Then, a center coordinate may be calculated according to the plurality of candidate coordinates (e.g., by calculating the coordinate of a geometrical center of the plurality of candidate coordinates), and then calculate the minimum value of the distances between the candidate coordinate corresponding to each element and the center coordinate, and then determine whether the distance is larger than a predetermined threshold (e.g., predetermined by a user, set based on a rule of thumb or past experiment). When a distance corresponding to an element (e.g., the tenth element) is larger than the predetermined threshold, the element in the high-dimensional encoded vector may be discarded before performing the dimensionality-reduction, and thereby generating the language processing vector.

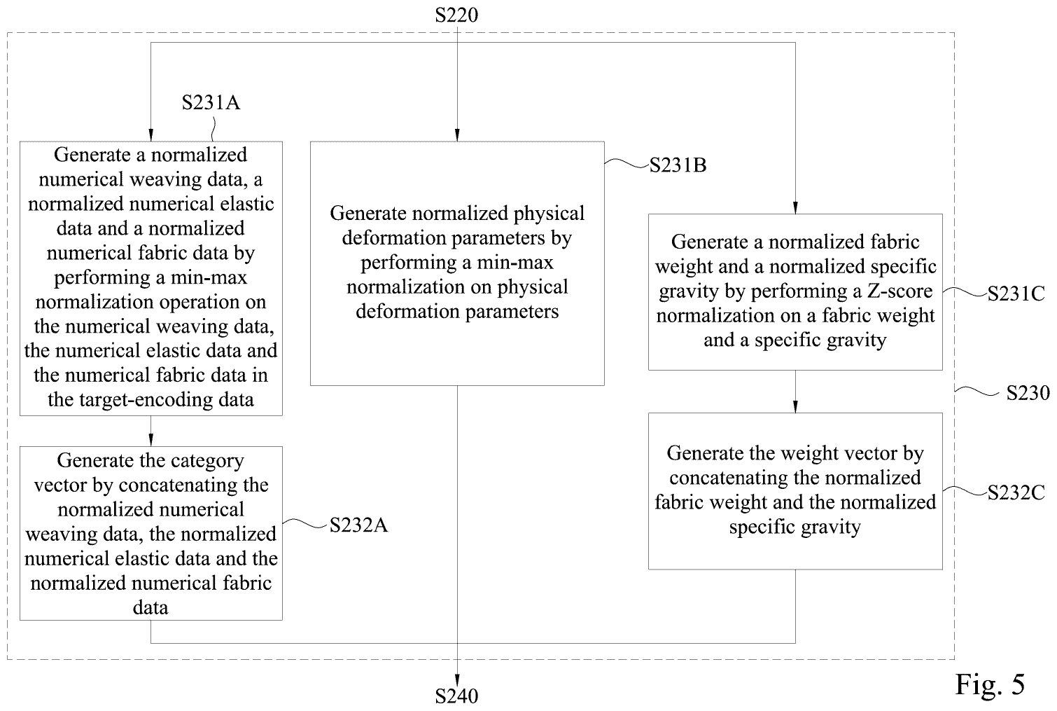

Refer also to FIG. 5, where FIG. 5 is a flowchart of detailed steps S231A-S232C of step S230 in FIG. 2 according to some embodiments of the present disclosure. As shown in FIG. 5, step S220 is conducted before entering step S321A and step S321B. In step S231A, the min-max normalization operation is performed on the numerical weaving data, the numerical elastic data and the numerical fabric data in the target-encoding data, so as to generate a normalized numerical weaving data, a normalized numerical elastic data and a normalized numerical fabric data. Then, step S232A is conducted.

In step S232A, the category vector CV is generated by concatenating the normalized numerical weaving data, the normalized numerical elastic data and the normalized numerical fabric data. In other words, a plurality of elements in the category vector CV are the normalized numerical weaving data, the normalized numerical elastic data and the normalized numerical fabric data, respectively.

In addition, in step S231B, a min-max normalization is performed on physical deformation parameters, so as to generate normalized physical deformation parameters.

In some embodiments, the min-max normalization operation mat be conducted on the bending work in the warp direction, the bending work in the weft direction, the stretch rate in the warp direction, the stretch rate in the weft direction or the stretch rate in the oblique direction, so as to generate corresponding a normalized bending work in the warp direction, a normalized bending work in the weft direction, a normalized stretch rate in the warp direction, a normalized stretch rate in the weft direction or a normalized stretch rate in the oblique direction.

It is worth mentioning that since outliers lying outside a particular range in the target-encoding data, the bending work in the warp direction, the bending work in the weft direction, the stretch rate in the warp direction, the stretch rate in the weft direction or the stretch rate in the oblique direction are all discarded through box plots, the data are confined in the particular range (i.e., within a particular numerical range, where possible minimum and maximum values are known). Therefore, the min-max normalization is adopted here.

In other words, normalized physical deformation parameters may be the normalized bending work in the warp direction, the normalized bending work in the weft direction, the normalized stretch rate in the warp direction, the normalized stretch rate in the weft direction or the normalized stretch rate in the oblique direction.

In step S231C, the Z-score normalization is performed on the fabric weight and the specific gravity, so as to generate a normalized fabric weight and a normalized specific gravity. Then, step S232C is conducted.

In some embodiments, the second normalization NM2 is conducted on the fabric weight and the specific gravity through the Z-score normalization.

It is worth mentioning that since the fabric weight and the specific gravity may not be confined within a particular range (i.e., without a particular numerical range, where possible minimum and maximum values are unknown), the Z-score is adopted here.

In step S232C, the weight vector is generated by concatenating the normalized fabric weight and the normalized specific gravity. In other words, the normalized fabric weight is used as a first element in a two-dimensional vector, and the normalized specific gravity is used as a second element in the two-dimensional vector.

Then, step S232A, step 231B and step S232C are conducted before S240.

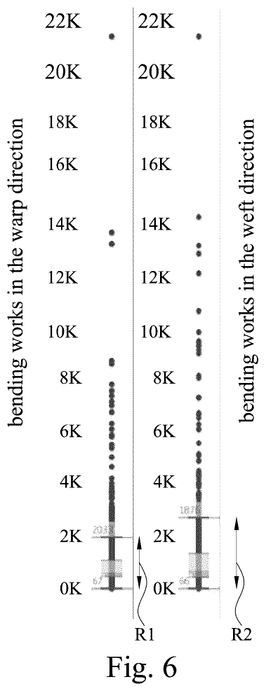

Refer also to FIG. 6, where FIG. 6 is a schematic diagram of a data filtering process through a box plot. As shown in FIG. 6, where bending works in the warp direction and bending works in the weft direction are taken as an example, for bending works in the warp direction, a numerical range R1 may be set as the range of 1.5 times of the interquartile range. By this, physical deformation parameters and the fabric specification information corresponding to fabrics that corresponds to points lying outside the numerical range R1 may be discarded. In addition, for bending works in the weft direction, a numerical range R2 may be set as the range of 1.5 times of the interquartile range. By this, physical deformation parameters and the fabric specification information corresponding to fabrics that corresponds to points lying outside the numerical range R2 may be discarded. Other data in physical deformation parameters and fabric specification information may be used in the same manner.

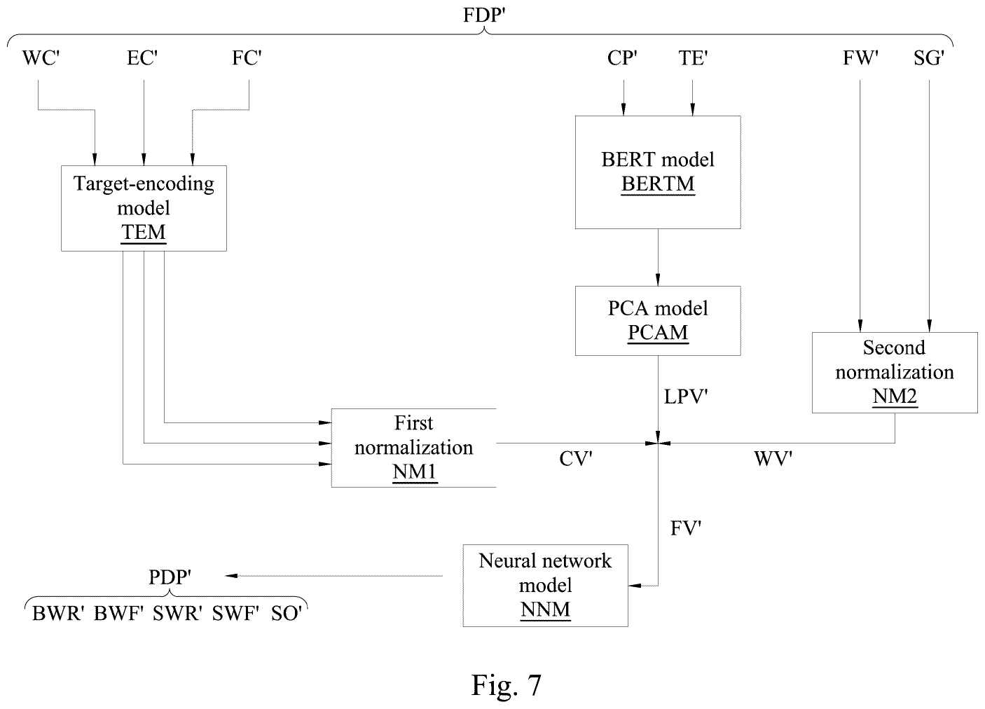

Refer also to FIG. 7, where FIG. 7 is a schematic diagram of deployment stage of the fabric simulation device 100 according to some embodiments of the present disclosure. As shown in FIG. 7, in the deployment stage, when a new fabric (or the fabric FB used in the training stage) is to be simulated without measuring physical deformation parameters of the new fabric, the data capturing circuit 110 may be configured to capture a new fabric specification information FDP′ obtained in the manufacturing stage (or provided by the manufacturer), where the new fabric specification information FDP′ corresponds to the new fabric.

Then, a new weaving category WC′, a new elastic category EC′ and a new fabric category FC′ in the new fabric specification information FDP′ may be processed by the target-encoding model TEM and the first normalization operation NM1, so as to generate a new category vector CV′. Then, a new composition combination CP′ and a new textile-finishing combination TF′ in the new fabric specification information FDP′ may be processed by the BERT model BERTM and the PCA operation, so as to generate a new language processing vector LPV′. Then, a new fabric weight FW′ and a new specific gravity in the new fabric specification information FDP′ may be processed by the second normalization operation NM2, so as to generate a new weight vector WV′.

Then, the new category vector CV′, the language processing vector LPV′ and the new weight vector W′ may be concatenated, so as to generate a new feature vector FV′. Finally, the new feature vector FV′ is inputted to the neural network model NNM, where the neural network model NNM transforms the new feature vector FV′ into new physical deformation parameters PDP′ corresponding to the new fabric, while new physical deformation parameters PDP′ may be a new bending work in the warp direction BWR′, a new bending work in the weft direction BWF′, a new stretch rate in the warp direction SWR′, a new stretch rate in the weft direction SWF′ and a new stretch rate in the oblique direction SO′.

It is worth mentioning that while a single neural network model NNM is taken as an example here, in practical implementation, the feature vector FV′ inputted to the neural network model NNM for the bending work in the warp direction BWR, the neural network model NNM for the bending work in the weft direction BWF, the neural network model NNM for the stretch rate in the warp direction SWR, the neural network model NNM for the stretch rate in the weft direction SWF and the neural network model NNM for the stretch rate in the oblique direction SO, so as to generate the new bending work in the warp direction BWR′, the new bending work in the weft direction BWF′, the new stretch rate in the warp direction SWR′, the new stretch rate in the weft direction SWF′ and the new stretch rate in the oblique direction SO′ from the neural network model NNM for the bending work in the warp direction BWR, the neural network model NNM for the bending work in the weft direction BWF, the neural network model NNM for the stretch rate in the warp direction SWR, the neural network model NNM for the stretch rate in the weft direction SWF and the neural network model NNM for the stretch rate in the oblique direction SO, respectively.

By this, the new bending work in the warp direction BWR′, the new bending work in the weft direction BWF′, the new stretch rate in the warp direction SWR′, the new stretch rate in the weft direction SWF′ and the new stretch rate in the oblique direction SO′ may be inputted to the simulation software, and the simulation software SS may simulate drapes, rotations or shakes of the new fabric in the virtual three-dimensional space 3DS, and the simulation display SD may display various drapes and motions of a virtual fabric 3DF in the virtual three-dimensional space 3DS.

To sum up, the fabric simulation device in the present disclosure utilizes a plurality of pre-processing model to transform physical deformation parameters the fabric specification information corresponding to fabrics into feature vectors and normalized physical deformation parameters, and uses feature vectors as training samples and normalized physical deformation parameters as training labels to train a neural network model. By this, as a new fabric specification information (which is easier to obtain) corresponding to a new fabric is inputted to a plurality of pre-processing models and a updated neural network model, new physical deformation parameters for simulating the new fabric may be generated. As a result, various drapes and motions of a virtual fabric may be simulated without measuring the deformations of the new fabric (which is more difficult to obtain), which may reduce time and manpower consumed by additional measurement of physical deformation parameters, and thereby improve the efficiency of fabric simulation in the three-dimensional virtual space.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the present disclosure. In view of the foregoing, it is intended that the present disclosure cover modifications and variations of this disclosure provided they fall within the scope of the following claims and their equivalents.

What is claimed is:

1. A fabric simulation device, comprising:
a data capturing circuit, configured to capture a physical deformation parameter corresponding to a fabric;
a memory, configured to store a fabric specification information corresponding to the fabric, wherein the fabric specification information comprises a fabric category data, a fabric combination data, and a fabric weight data; and
a processor, coupled to the data capturing circuit and the memory, configured to apply a neural network model, wherein the processor is configured to:
generate target-encoding data by conducting a target-encoding algorithm on the fabric category data;
generate a language processing vector by conducting a natural language processing algorithm on the fabric combination data;
generate a category vector and a normalized physical deformation parameter by conducting a first normalization operation on the target-encoding data and the physical deformation parameter, and generate a weight vector by conducting a second normalization operation on the fabric weight data;
generate a feature vector by concatenating the category vector, the language processing vector and the weight vector; and
update the neural network model according to the feature vector and the normalized physical deformation parameters.

2. The fabric simulation device of claim 1, wherein the fabric category data comprises a weaving category, an elastic category, and a fabric category, and the processor is further configured to:
generate a numerical weaving data, a numerical elastic data, and a numerical fabric data by conducting the target-encoding algorithm on the weaving category, the elastic category, and the fabric category, respectively; and
generate the target-encoding data by concatenating the numerical weaving data, the numerical elastic data, and the numerical fabric data.

3. The fabric simulation device of claim 1, wherein the fabric combination data comprises a composition combination and a textile-finishing combination, and the processor is further configured to:
generate an encoded vector by conducting a bidirectional encoder representations from transformers algorithm on the composition combination and the textile-finishing combination; and
generate the language processing vector by conducting a principal component analysis algorithm on the encoded vector.

4. The fabric simulation device of claim 3, wherein a dimensionality of the language processing vector is less than the dimensionality of the encoded vector.

5. The fabric simulation device of claim 1, wherein the first normalization operation is a min-max normalization operation.

6. The fabric simulation device of claim 5, wherein the processor is further configured to:
generate a normalized numerical weaving data, a normalized numerical elastic data, and a normalized numerical fabric data by conducting the first normalization operation on the numerical weaving data, the numerical elastic data, and the numerical fabric data in the target-encoding data;
generate the category vector by concatenating the normalized numerical weaving data, the normalized numerical elastic data, and the normalized numerical fabric data; and
generate the normalized physical deformation parameter by conducting the first normalization operation on the physical deformation parameter.

7. The fabric simulation device of claim 6, wherein the physical deformation parameters is a bending work in a warp direction, a bending work in a weft direction, a stretch rate in a warp direction, a stretch rate in a weft direction, or a stretch rate in an oblique direction.

8. The fabric simulation device of claim 1, wherein the second normalization operation is a Z-score normalization operation.

9. The fabric simulation device of claim 8, wherein the fabric weight data comprises a fabric weight and a specific gravity, and the processor is further configured to:
generate a normalized fabric weight and a normalized specific gravity by conducting the second normalization operation on the fabric weight and the specific gravity; and
generate the weight vector by concatenating the normalized fabric weight and the normalized specific gravity.

10. The fabric simulation device of claim 1, wherein the physical deformation parameter is obtained from the fabric by a detector machine and stored in the memory.

11. A fabric simulation method, being adapted for an electronic device, comprising:
generate target-encoding data by conducting a target-encoding algorithm on a fabric category data, wherein a fabric specification information corresponds to a fabric, and the fabric specification information comprises the fabric category data, a fabric combination data and a fabric weight data;
generate a language processing vector by conducting a natural language processing algorithm on the fabric combination data;
generate a category vector and a normalized physical deformation parameter by conducting a first normalization operation on the target-encoding data and a physical deformation parameter, and generate a weight vector by conducting a second normalization operation on the fabric weight data, wherein the physical deformation parameter corresponds to the fabric;
generate a feature vector by concatenating the category vector, the language processing vector and the weight vector; and
update a neural network model according to the feature vector and the normalized physical deformation parameter.

12. The fabric simulation method of claim 11, wherein the fabric category data comprises a weaving category, an elastic category, and a fabric category, wherein the step of generating the target-encoding data by conducting the target-encoding algorithm on the fabric category data in the fabric specification information comprises:
generate a numerical weaving data, a numerical elastic data and a numerical fabric data by conducting the target-encoding algorithm on the weaving category, the elastic category, and the fabric category, respectively; and
generate the target-encoding data by concatenating the numerical weaving data, the numerical elastic data, and the numerical fabric data.

13. The fabric simulation method of claim 11, wherein the fabric combination data comprises a composition combination and a textile-finishing combination, wherein and the step of generating the language processing vector by conducting the natural language processing algorithm on the fabric combination data comprises:
generate an encoded vector by conducting a bidirectional encoder representations from transformers algorithm on the composition combination and the textile-finishing combination; and
generate the language processing vector by conducting a principal component analysis algorithm on the encoded vector.

14. The fabric simulation method of claim 13, wherein a dimensionality of the language processing vector is less than the dimensionality of the encoded vector.

15. The fabric simulation method of claim 11, wherein the first normalization operation is a min-max normalization operation.

16. The fabric simulation method of claim 15, wherein the step of generating the category vector and the normalized physical deformation parameters by conducting the first normalization operation on the target-encoding data and the physical deformation parameters comprises:
generate a normalized numerical weaving data, a normalized numerical elastic data and a normalized numerical fabric data by conducting the first normalization operation on the numerical weaving data, the numerical elastic data, and the numerical fabric data in the target-encoding data;
generate the category vector by concatenating the normalized numerical weaving data, the normalized numerical elastic data, and the normalized numerical fabric data; and
generate the normalized physical deformation parameter by conducting the first normalization operation on the physical deformation parameter.

17. The fabric simulation method of claim 16, wherein the physical deformation parameters is a bending work in a warp direction, a bending work in a weft direction, a stretch rate in a warp direction, a stretch rate in a weft direction, or a stretch rate in an oblique direction.

18. The fabric simulation method of claim 11, wherein the second normalization operation is a Z-score normalization operation.

19. The fabric simulation method of claim 11, wherein the fabric weight data comprises a fabric weight and a specific gravity, and the step of generating the weight vector by conducting the second normalization operation on the fabric weight data comprises:
generate a normalized fabric weight and a normalized specific gravity by conducting the second normalization operation on the fabric weight and the specific gravity; and
generate the weight vector by concatenating the normalized fabric weight and the normalized specific gravity.

20. The fabric simulation method of claim 11, wherein the physical deformation parameter is obtained from the fabric by a detector machine and stored in the electronic device.
